(19) United States
(12) Patent Application Publication
(10) Pub. No.: US 2010/0260517 A1
(43) Pub. Date: Oct. 14, 2010

(54) Electrophotographic Photosensitive Body and Image Forming Device Having an Electrophotographic Photosensitive Body

(75) Inventor: Yoshinobu Ishii, Shiga (JP)

Correspondence Address: VOLPE AND KOENIG, P.C., UNITED PLAZA, 30 SOUTH 17TH STREET, PHILADELPHIA, PA, 19103, US

(73) Assignee: KYOCERA CORPORATION, Kyoto (JP)

(21) Appl. No.: 12/675,602

(22) PCT Filed: Aug. 25, 2008
(86) PCT No.: PCT/JP2008/065090

§ 371 Date: Apr. 2, 2010

(30) Foreign Application Priority Data
Aug. 29, 2007 (JP) 2007-223213

(51) Int. Cl. G03G 15/00; G03G 5/04; G03G 5/043

(52) U.S. Cl. 399/159; 430/66; 430/64

(57) ABSTRACT

A negative charging electrophotographic photosensitive body has a base, a photoconductive layer made of an amorphous silicon compound and formed amorphous silicon compound and formed on the base, a charge injection blocking layer formed on the photoconductive layer, and a surface layer formed on the charge injection blocking layer. The charge injection blocking layer contains at least one element selected from a group of N, O, and C and a group-13 element. The optical absorption coefficient of the charge injection blocking layer is smaller than that of the photoconductive layer, and the difference between the refractive index of the photoconductive layer and that of the charge injection blocking layer is greater than 0 and less than 0.9.

### TECHNICAL FIELD

The present invention relates to an electrophotographic photoreceptor in which a photosensitive layer is formed on a base and an electrophotographic image forming device provided with the electrophotographic photoreceptor.

### BACKGROUND ART

In image forming devices employing an electrophotographic system, an electrophotographic photoreceptor in which a film layer containing a photosensitive layer is formed on the outer circumferential surface of an aluminum cylindrical base, for example. Such an electrophotographic photoreceptor is classified into a positive charging electrophotographic photoreceptor in which the surface charge is positive and a negative charging electrophotographic photoreceptor in which the surface charge is negative. In general, the positive charging electrophotographic photoreceptor is provided, on a cylindrical base, with a film layer in which a charge injection blocking layer, a photoconductive layer, and a surface layer are formed in order and the negative charging electrophotographic photoreceptor is provided, on a cylindrical base, with a film layer in which a photoconductive layer, a charge injection blocking layer, and a surface layer are formed in order. More specifically, the negative charging electrophotographic photoreceptor is provided with the charge injection blocking layer on the photoconductive layer, unlike the positive charging electrophotographic photoreceptor. Examples of the negative charging electrophotographic photoreceptor having such a structure include one disclosed in Patent Document 1.

In electrophotographic photoreceptors, an electrostatic latent image is usually formed by charging the entire image formation region on the surface, and then emitting exposure light according to a desired image. Then, the formed electrostatic latent image is developed by a toner or the like, and then the toner image is transferred to a recording medium. Then, the toner remaining on the electrophotographic photoreceptor that has been subjected to transferring is removed by cleaning, and then the electrophotographic photoreceptor is irradiated with neutralization light to eliminate the formed electrostatic latent image. Thus, when image formation is performed by the electrophotographic photoreceptor, it is necessary to appropriately perform, charging, exposure by exposure light, or neutralization by neutralization light. When the respective processes cannot be appropriately performed, the image properties decrease in some cases. Specifically, when charging or exposure is insufficient, the contrast of images to be formed decreases in some cases. When neutralization is insufficient, the image quality decreases due to residual potential in some cases. Then, there is a tendency that such a reduction in image properties is likely to cause problems particularly in the negative charging electrophotographic photoreceptor provided with the charge injection blocking layer on the photoconductive layer.
Patent Document 1: Japanese Unexamined Patent Application Publication No. 7-120952

### DISCLOSURE OF INVENTION

### Problems to be Solved by the Invention

The present invention has been devised under such circumstances. It is an object of the invention is to provide an electrophotographic photoreceptor and an image forming device that can suppress a reduction in image quality due to residual potential while sufficiently maintaining the contrast of images to be formed.

### Means for Solving the Problems

According to an aspect of the present invention, an electrophotographic photoreceptor has a base, a photoconductive layer on the base, a charge injection blocking layer on the photoconductive layer, and a surface layer on the charge injection blocking layer. The photoconductive layer contains a non-single crystal material mainly containing a silicon atom. The charge injection blocking layer contains at least one element selected from the group consisting of N, O, and C and the Group 13 elements. The optical absorption coefficient of the charge injection blocking layer is smaller than the optical absorption coefficient of the photoconductive layer. The difference between the refractive index of the photoconductive layer and the refractive index of the charge injection blocking layer is more than 0 and 0.9 or lower.

According to another aspect of the present invention, an image forming device has the above-described electrophotographic photoreceptor.

### Effects of the Invention

An electrophotographic photoreceptor or an image forming device according to an aspect of the present invention can more effectively perform exposure or neutralization, and thus is preferable in terms of suppressing a reduction in image quality due to residual potential while sufficiently maintaining the contrast of images to be formed.

### BEST MODES FOR CARRYING OUT THE INVENTION

FIG. 1 is a view showing the schematic structure of an image forming device 1 according to one embodiment of the present invention. The image forming device 1 employs the Karlsson method as an image formation system. The image forming device 1 is provided with an electrophotographic photoreceptor 10, a charging unit 11, an exposure unit 12, a development unit 13, a transfer unit 14, a fixing unit 15, a cleaning unit 16, and a neutralization unit 17.

The charging unit 11 has a function of positively or negatively charging the electrophotographic photoreceptor 10. The charging voltage is adjusted to, for example, 200 V or more and 1000 V or lower. In this embodiment, the charging unit 11 is described employing a contact type charging unit but a non-contact charging unit may be employed in place of the contact type charging unit. The contact type charging unit is disposed in such a manner as to press the electrophotographic photoreceptor 10 and is constituted by, for example, covering a core metal with a conductive rubber and PVDF (polyvinylidene fluoride). The non-contact charging unit is disposed apart from the electrophotographic photoreceptor 10 and has a discharge wire, for example.

The exposure unit 12 has a function of forming an electrostatic latent image on the electrophotographic photoreceptor 10. Specifically, the exposure unit 12 forms the electrostatic latent image by irradiating the electrophotographic photoreceptor 10 with exposure light having a specific wavelength (e.g., 650 nm or more and 780 nm or lower) according to an image signal to thereby attenuate the potential of the exposure light-irradiated portion of the charged electrophotographic photoreceptor 10. As the exposure unit 12, an LED head in which a plurality of LED devices are arranged can be employed, for example.

It is a matter of course that, as a light source of the exposure unit 12, a light source capable of emitting laser light can also be used in place of the LED device. Specifically, an optical system containing a polygon mirror may be employed in place of the exposure unit 12, such as the LED head. By employing as the light source of the exposure unit 12 an optical system containing a lens or mirror through which reflected light from an original document passes, it can be applied to a structure of a copying machine as an image forming device.

The development unit 13 has a function of developing the electrostatic latent image of the electrophotographic photoreceptor 10 to form a toner image. The development unit 13 in this embodiment is provided with a magnetic roller 13A that magnetically holds a developer (toner) TN.

The developer TN constitutes a toner image to be formed on the surface of the electrophotographic photoreceptor 10 and is frictionally charged in the development unit 13. Examples of the developer TN include a two-component developer containing a magnetic career and an insulating toner and a one-component developer containing a magnetic toner.

The magnetic roller 13A has a function of conveying the developer to the surface (development region) of the electrophotographic photoreceptor 10. The magnetic roller 13A conveys the developer TN which has been frictionally charged in the development unit 13 in the form of a magnetic brush adjusted to a fixed length. The conveyed developer TN adheres to the surface of the photoreceptor with electrostatic attraction with the electrostatic latent image in the development region of the electrophotographic photoreceptor 10 to form a toner image (visualizing the electrostatic latent image). The charge polarity of the toner image is adjusted to be opposite to the charge polarity of the surface of the electrophotographic photoreceptor 10 when image formation is performed by normal development. When image formation is performed by reversal development, the charge polarity of the toner image is adjusted to be the same as the charge polarity of the surface of the electrophotographic photoreceptor 10.

In this embodiment, the development unit 13 employs a dry developing system but a wet developing system using a liquid developer may be employed.

The transfer unit 14 has a function of transferring the toner image of the electrophotographic photoreceptor 10 to a recording medium P supplied to the transfer region between the electrophotographic photoreceptor 10 and the transfer unit 14. The transfer unit 14 in this embodiment is provided with a transfer charger 14A and a separation charger 14B. In the transfer unit 14, the back surface (non recording surface) of the recording medium P is charged to a polarity opposite to that of the toner image in the transfer charger 14A, and then the toner image is transferred onto the recording medium P by the electrostatic attraction between the charged charge and the toner image. In the transfer unit 14, the back surface of the recording medium P is alternatingly charged in the separation charger 14B simultaneously with the transfer of the toner image, and then the recording medium P is promptly separated from the surface of the electrophotographic photoreceptor 10.

As the transfer unit 14, a transfer roller that follows the rotation of the electrophotographic photoreceptor 10 and is disposed apart from the electrophotographic photoreceptor 10 through a minute gap (usually 0.5 mm or lower) can also be used. The transfer roller is constituted in such a manner as to apply a transfer voltage, which attracts the toner image on the electrophotographic photoreceptor 10 onto the recording medium P, by, for example, a direct-current power supply. When the transfer roller is used, a transfer separation device such as the separation charger 14B can also be omitted.

The fixing unit 15 has a function of fixing the toner image transferred to the recording medium P to the recording medium P and is provided with a pair of fixing rollers 15A and 15B. For the fixing rollers 15A and 15B, a metal roller whose surface is coated with fluororesin or the like is used, for example. In the fixing unit 15, the toner image can be fixed to the recording medium P by applying heat, pressure, or the like to the recording medium P that is made to pass between the pair of fixing rollers 15A and 15B.

The cleaning unit 16 has a function of removing the toner remaining on the surface of the electrophotographic photoreceptor 10 and is provided with a cleaning blade 16A. The cleaning blade 16A has a function of scratching the residual toner off from the surface of the electrophotographic photoreceptor 10. The cleaning blade 16A is structured to have desired elasticity by a rubber material or the like containing polyurethane resin as the main ingredients, for example.

The neutralization unit 17 has a function of removing the charge (residual electrostatic latent image) of the electrophotographic photoreceptor 10 and can emit light having a specific wavelength (e.g., 780 nm or more). The neutralization unit 17 is constituted so that the charge of the electrophotographic photoreceptor 10 is removed by emitting light to the entire surface of the electrophotographic photoreceptor 10 in the axis direction by, for example, a light source, such as LED.

FIG. 2 is a cross sectional view showing the schematic structure of the electrophotographic photoreceptor 10. The electrophotographic photoreceptor 10 has a base 18 and a photosensitive layer 19 and an electrostatic latent image or a toner image based on an image signal is formed thereon. The electrophotographic photoreceptor 10 can be rotated in the direction of arrow A of FIG. 1 by a rotation mechanism outside FIG. 1.

The base 18 has a function as a support base of the electrophotographic photoreceptor 1 and has conductivity at least in the surface. The base 18 in this embodiment has a cylindrical shape, but the shape is not limited thereto and, for example, the shape of an endless belt may be acceptable. The base 18 is formed with metal materials or alloy materials containing the metal materials so that the substantially entire base 18 has conductivity. Examples of the metal materials include aluminum (Al), stainless steel (SUS), zinc (Zn), copper (Cu), iron (Fe), titanium (Ti), nickel (Ni), chromium (Cr), tantalum (Ta), tin (Sn), gold (Au), and silver (Ag). The base 18 may be constituted so that the surface of an insulator is coated with a conductive film. Examples of component materials of the insulator include insulation materials, such as resin, glass, and ceramics. Examples of component materials of the conductive film include the above-mentioned metal materials and alloy materials and transparent conductive materials, such as ITO (Indium Tin Oxide) and SnO₂. As the base 18 having such a structure, bases employing Al materials as the component materials are preferable and, in particular, bases employing Al materials for the entire bases are more preferable, from the viewpoint of reducing the weight and cost. Examples of the Al materials include an Al—Mn alloy, an Al—Mg alloy, and an Al—Mg—Si alloy. The base 18 employing the Al materials is preferable in terms of increasing the adhesiveness (consequently, reliability) between the base 18 and the photosensitive layer 19 when the photosensitive layer 19 to be formed on the outer circumferential surface of the base 18 is formed with a-Si materials.

The formation surface of the photosensitive layer 19 in the base 18 is subjected to surface treatment by a turning machine or the like. Examples of the surface treatment include mirror surface processing and a linear groove processing.

The photosensitive layer 19 is formed on an outer circumferential surface 18a of the base 18. The thickness of the photosensitive layer 19 is set to, for example, 15 μm or more and 120 μm or lower. When the thickness of the photosensitive layer 19 is set to 15 μm or more, the interference fringes in a record image can be reduced even when a long wavelength light absorption layer or the like is not provided. When the thickness of the photosensitive layer 19 is set to 120 μm or lower, the separation of the photosensitive layer 19 from the base 18 due to a stress can be appropriately suppressed.

In this embodiment, the photosensitive layer 19 is obtained by laminating the photoconductive layer 19A, the charge injection blocking layer 19B, and the surface layer 19C.

The photoconductive layer 19A has a function of generating a career by irradiation of light, such as laser light. The photoconductive layer 19A is constituted by a non-single crystal material mainly containing silicon, such as a-Si, a-SiC, a-SiN, a-SiO, a-SiGe, a-SiCN, a-SiNO, a-SiCO, and a-SiCNO, for example. The non-single crystal material refers to materials containing at least one portion of polycrystalline, microcrystalline, and amorphous portions. When the photoconductive layer 19A contains microcrystallite silicon, dark conductivity or light conductivity can be increased. Thus, the degree of freedom for design of the photoconductive layer 19A can be increased. Such microcrystalline silicon can be formed by changing film forming conditions. For example, when a glow discharge decomposition method is employed, the microcrystalline silicon can be formed by adjusting the temperature and the direct-current pulse power of the base 18 to be high and increasing the flow rate of diluent gas (e.g., hydrogen).

It is preferable for the photoconductive layer 19A to contain at least either one of hydrogen or halogen elements (F, Cl, etc.) from the viewpoint of compensating a dangling bond of silicon. The total proportion of hydrogen and halogen elements contained in the photoconductive layer 19A is preferably adjusted to 1% by atom or more and 40% by atom or lower relative to the total proportion of silicon, hydrogen, and halogen elements. Examples of raw materials for introducing silicon into the photoconductive layer 19A include silicon hydrides (silanes), such as SiH₄, Si₂H₆, Si₃H₈, and Si₄H₁₀. Among the above, SiH₄ and Si₂H₆ are particularly preferable from the viewpoint of the supply efficiency or ease of handling of silicon. Examples of raw materials for introducing the halogen elements into the photoconductive layer 19A include F₂, BrF, ClF, ClF₃, BrF₃, BrF₅, IF₃, IF₇, SiF₄, and Si₂F₆. The raw materials for introducing silicon into the photoconductive layer 19A may be diluted with at least either one of H₂ or He as required. In order to control the content of the hydrogen or the halogen elements in the photoconductive layer 19A, the temperature of the base 18, the supply amount of raw materials for introducing each element into the photoconductive layer 19A, the discharge electric power etc., may be adjusted, for example.

In order to obtain desired properties of electrical properties, such as dark conductivity, or an optical band gap, the photoconductive layer 19A may contain at least either elements of Group 13 of the periodic table (hereinafter abbreviated as Group 13 elements) or elements of Group 15 of the periodic table (hereinafter abbreviated as Group 15 elements). When the Group 13 elements are contained in the photoconductive layer 19A, the content of the Group 13 elements is adjusted to 0.01 ppm or more and 200 ppm or lower. When the Group 15 elements are contained in the photoconductive layer 19A, the content of the Group 15 elements is adjusted to 0.01 ppm or more and 100 ppm or lower. The Group 13 elements or the Group 15 elements contained in the photoconductive layer 19A may be substantially uniformly dispersed in the photoconductive layer 19A or may be partially unevenly dispersed therein in the layer thickness direction. However, from the viewpoint of increasing the optical sensitivity, it is preferable that the elements be dispersed so that the concentration thereof in the end region at the side of the base 18 is lower than that in the end region at the side of the surface layer 19C (opposite to the base 18). Thus, when the content gradient of the Group 13 elements or the Group 15 elements is provided in the layer thickness direction, the average content thereof in the entire conductive layer 19A is within the range mentioned above. In either case, the elements are preferably dispersed in the in-plane direction parallel to the surface of the base 18 from the viewpoint of equalizing the properties in the in-plane direction.

Examples of the Group 13 elements include boron (B), aluminum (Al), gallium (Ga), indium (I), and thallium (Tl). Among the above, from the viewpoint of ease of controlling the doping concentration during film formation by a CVD method, boron is particularly preferable. Examples of raw materials for introducing the Group 13 elements into the photoconductive layer 19A include boron hydrides, such as B₂H₆, B₄H₁₀, B₅H₉, B₅H₁₁, B₆H₁₀, B₆H₁₂, and B₆H₁₄, boron halides such as BF₃, BCl₃, and BBr₃, AlCl₃, GaCl₃, Ga(CH₃)₃, InCl₃, and TlCl₃.

Examples of the Group 15 elements include phosphorous (P), arsenic (As), antimony (Sb), and bismuth (Bi). Among the above, from the viewpoint of reducing distortion of a lattice resulting from the difference in the diameter of an atom from silicon mainly constituting the non-single crystal material constituting the photoconductive layer 19A, phosphorous is particularly preferable. Examples of raw materials for introducing the Group 15 elements into the photoconductive layer 19A include phosphorous hydrides, such as PH₃ or P₂H₄, phosphorus halides, such as PF₃, PF₅, PCl₃, PCl₅, PBr₃, PBr₅, and PI₃, AsII₃, ASF₃, AsCl₃, AsBr₃, ASF₅, SbII₃, SbF₃, SbF₅, SbCl₃, SbCl₅, BiH₃, BiCl₃, and BiBr₃.

The photoconductive layer 19A may contain at least one element of carbon (C), oxygen (O), and nitrogen (N). The total proportion of carbon, oxygen, and nitrogen contained the photoconductive layer 19B is preferably 1×10⁻⁵% by atom or more and 2% by atom or lower relative to the total proportion of the elements and silicon.

The thickness of the photoconductive layer 19A is set to 5 μm or more and 100 μm or lower (preferably 10 μm or more and 80 μm or lower) from the viewpoint of desired electrophotographic properties and economical effects. When the thickness of the photoconductive layer 19A is 5 μm or more and 100 μm or lower, the charging ability or optical sensitivity can be sufficiently secured, the formation time does not become longer than necessary, and the manufacturing cost can be reduced.

The charge injection blocking layer 19B has a function of blocking the injection of the charge charged on the vicinity of the surface of the photosensitive layer 19 into the side of the photoconductive layer 19A. The charge injection blocking layer 19B is constituted by the non-single crystal material mainly containing silicon. For example, when the charge injection blocking layer 19B is formed with amorphous silicon (a-Si) materials, examples of a raw material gas include a mixed gas obtained by mixing an Si containing gas, such as SiH₄ (silane gas), a dopant containing gas, such as B₂H₆, and a diluent gas, such as hydrogen (H₂) and a helium (He).

The charge injection blocking layer 19B contains the Group 13 elements from the viewpoint of more appropriately forming an energy barrier. The content of the Group 13 elements in the charge injection blocking layer 19B is preferably adjusted in such a manner as to be higher than the content of the Group 13 elements in the photoconductive layer 19A, and, for example, is adjusted to 0.1 ppm or more and 20000 ppm or lower. The Group 13 elements contained in the charge injection blocking layer 19B may be substantially uniformly dispersed in the charge injection blocking layer 19A or may be partially unevenly dispersed therein in the layer thickness direction. However, from the viewpoint of reducing the generation of residual charge, it is preferable that the elements be substantially uniformly dispersed. Thus, when the content gradient of the Group 13 elements is provided in the layer thickness direction, the average content thereof in the entire charge injection blocking 19B is within the range mentioned above. In either case, it is preferable that the elements be substantially uniformly dispersed in the in-plane direction parallel to the surface of the base 18 from the viewpoint of equalizing the properties in the in-plane direction.

To the charge injection blocking layer 19B, at least one element of carbon (C), oxygen (O), and nitrogen (N) is added from the viewpoint of enlarging the optical band gap (reducing the optical absorption coefficient). The added element may be substantially uniformly dispersed in the charge injection blocking layer 19B and may be partially unevenly dispersed therein in the layer thickness direction. When the dispersion concentration is uneven, the element is preferably added so that the concentration of the added element at the side of the base 18 becomes high from the viewpoint of reducing the generation of residual charge. In either case, it is preferable that the elements be substantially uniformly dispersed in the in-plane direction parallel to the surface of the base 18 from the viewpoint of equalizing the properties in the in-plane direction.

The thickness of the charge injection blocking layer 19B is set to 0.1 μm or more and 10 μm or lower from the viewpoint of desired electrophotographic properties and economical effects. When the thickness of the charge injection blocking layer 19B is 0.1 μm or more and 10 μm or lower, the injection of charge from the side of the surface layer 19C can be sufficiently blocked and the generation of residual charge can sufficiently be suppressed.

The surface layer 19C has a function of increasing the moisture resistance, the repeated use properties, the electrical pressure resistance, the use environment properties, or the durability mainly of the electrophotographic photoreceptor 10. The surface layer 19C is constituted by a non-single crystal material mainly containing at least either one of silicon or carbon, for example. The surface layer 19C has a sufficiently large optical band gap relative to emitted light so that light, such as laser light, emitted to the electrophotographic photoreceptor 10 is not unsuitably absorbed. The surface layer 19C is constituted in such a manner as to have resistance (generally 10¹¹ Ω·cm or more) which allows holding the electrostatic latent image in image formation.

When the surface layer 19C is formed with a-SiC materials, examples of a raw material gas include a mixed gas obtained by mixing an Si containing gas, such as SiH₄ (silane gas), and a C containing gas, such as CH₄. The composition ratio of Si and C in the raw material gas may be changed continuously or intermittently. For example, since there is a tendency that the film formation rate decreases with an increase in the proportion of C, the surface layer 19C may be formed so that the C proportion is low in a portion near the photoconductive layer 19B and the C proportion in the side of a free surface is high. When the surface layer 19C is formed with amorphous silicon carbide hydride (a-Si₁₋ₓCₓ:H) the X value (carbon proportion) is preferably adjusted to 0.55 or more and lower than 0.93 (preferably 0.6 or more and 0.7 or lower) from the viewpoint of durability.

In contrast, when the surface layer 19C is formed with amorphous carbon (a-C) materials, examples of a raw material gas include a C containing gas, such as C₂H₂ (acetylene gas) and CH₄ (methane gas). The film thickness of the surface layer 19C in this case is set to, for example, 0.1 μm or more and 2.0 μm or lower. Thus, when the surface layer 19C is formed with a-C materials, the oxidation of the surface of the surface layer 19C can be more certainly suppressed because the binding energy of C—O bond is relatively smaller than that of Si—O bond, compared with the case where the surface layer 19C is formed with a-Si materials. More specifically, when the surface layer 19C is formed with a-C materials, the oxidation of the surface of the surface layer 19C due to ozone or the like generated by corona discharge during printing can be more appropriately suppressed, and, consequently, image flow under a high temperature and high humidity environment or the like can be more appropriately suppressed.

It is preferable for the surface layer 19C to contain at least either one of hydrogen or halogen elements from the viewpoint of compensating a dangling bond of silicon. The content of hydrogen in the surface layer 19C is preferably adjusted to 1% by atom or more and 70% by atom or lower (preferably 1% by atom or more and 45% by atom or lower) relative to the total proportion of component elements. When the content of hydrogen in the surface layer 19C is 1% by atom or more and 70% by atom or lower, effects obtained by incorporating hydrogen can be sufficiently obtained and the trap of charge generated when the surface of the surface layer 104 is irradiated with light can be sufficiently suppressed (consequently, the occurrence of image defects due to residual potential can be sufficiently suppressed).

The thickness of the surface layer 19C is set to 0.2 μm or more and 1.5 μm or lower (preferably 0.5 μm or more and 1 μm or lower) from the viewpoint of durability or residual potential. When the thickness of the surface layer 19C is 0.2 μm or more and 1.5 μm or lower, the occurrence of image flaws or image concentration unevenness can be sufficiently suppressed by printing resistance and the occurrence of image defects due to residual potential can be sufficiently suppressed.

The photosensitive layer 19 may further contain a charge injection blocking layer 19 D to be formed between the base 18 and the photoconductive layer 19A as shown in FIG. 2(b).

The charge injection blocking layer 19 D has a function of blocking the injection of a career from the base 18 into the side of the photoconductive layer 19A. The charge injection blocking layer 19D is constituted by a non-single crystal material mainly containing silicon, for example. For example, when the charge injection blocking layer 19D is formed with a-Si materials, examples of a raw material gas include a mixed gas or the like obtained by mixing an Si containing gas, such as SiH₄ (silane gas), a dopant containing gas, such as P₂H₄, and a diluent gas, such as hydrogen (H₂) and a helium (He).

The charge injection blocking layer 19D may contain either the Group 13 elements or the Group 15 elements from the viewpoint of appropriately forming an energy barrier. The Group 13 elements or the Group 15 elements contained in the charge injection blocking layer 19D may be substantially uniformly dispersed in the charge injection blocking layer 19D or may be partially unevenly dispersed therein in the layer thickness direction. However, from the viewpoint of suppressing the generation of residual charge, it is preferable that the elements be substantially uniformly dispersed. Thus, when the content gradient of the Group 13 elements or the Group 15 elements is provided in the layer thickness direction, the average content thereof in the entire charge injection blocking layer 19D is within the range mentioned above. In either case, it is preferable that the elements be substantially uniformly dispersed in the in-plane direction parallel to the surface of the base 18 from the viewpoint of equalizing the properties in the in-plane direction.

To the charge injection blocking layer 19D, at least one element of carbon (C), oxygen (O), and nitrogen (N) may be added. The added element may be substantially uniformly dispersed in the charge injection blocking layer 19D or may be partially unevenly dispersed therein in the layer thickness direction. However, when the dispersion concentration is uneven, the element is preferably added so that the concentration of the added element at the side of the base 18 becomes high from the viewpoint of suppressing the generation of residual charge and increasing the adhesiveness. In either case, it is preferable that the elements be substantially uniformly dispersed in the in-plane direction parallel to the surface of the base 18 from the viewpoint of equalizing the properties in the in-plane direction.

When the Group 13 elements or the Group 15 elements are incorporated with elements, such as carbon (C) and oxygen (O), into the charge injection blocking layer 19D, the content of the Group 13 elements is adjusted to 0.1 ppm or more and 20000 ppm or lower and the content of the Group 15 elements is adjusted to 0.1 ppm or more and 10000 ppm or lower. When elements, such as carbon (C) and oxygen (O), are not incorporated into the charge injection blocking layer 19D, the content of the Group 13 elements is adjusted to 0.01 ppm or more and 200 ppm or lower and the content of the Group 15 elements is adjusted to 0.01 ppm or more and 100 ppm or lower.

The thickness of the charge injection blocking layer 19D is set to 2 μm or more and 10 μm or lower from the viewpoint of desired electrophotographic properties and economical effects. When the thickness of the charge injection blocking layer 19D is 2 μm or more and 10 μm or lower, the injection of charge from the side of the base 18 can be sufficiently suppressed and the generation of residual charge can be sufficiently suppressed.

FIG. 3 is a schematic view showing an example of a plasma CVD device 2 forming the photoconductive layer 19A, the charge injection blocking layer 19B, and the surface layer 19C in the electrophotographic photoreceptor 10.

The plasma CVD device 2 is provided with a reaction chamber 20, a support mechanism 30, a direct-current voltage supply mechanism 40, a temperature control mechanism 50, a rotation mechanism 60, a gas supply mechanism 70, and an exhaust mechanism 80.

The reaction chamber 20 is a space for forming a deposition film on the base 18 and is defined by a cylindrical electrode 21, a pair of plates 22 and 23, insulation members 24 and 25.

The cylindrical electrode 21 defines a formation space of the deposition film and has a function as a first conductor. The cylindrical electrode 21 according to this embodiment is constituted by the same conductive material as that of the base 18 and is joined to the pair of plates 22 and 23 through the insulation members 24 and 25. The cylindrical electrode 21 in this embodiment is formed so that the distance between the base 18 supported by the support mechanism 30 and the cylindrical electrode 21 is 10 mm or more and 100 mm or lower. This is because when the distance between the base 18 and cylindrical electrode 21 is smaller than 10 mm, stable discharge is difficult to achieve between the base 18 and the cylindrical electrode 21 in some cases and when the distance between the base 18 and cylindrical electrode 21 is larger than 100 mm, the plasma CVD device 2 becomes larger than necessary and the productivity per unit installation area decreases in some cases.

The cylindrical electrode 21 has a gas introduction port 21a and a plurality of gas outlets 21b, and one end thereof is grounded. The grounding of the cylindrical electrode 21 is not essential and the cylindrical electrode 21 may be connected to another standard power supply different from a direct-current power supply 41 described later. When the cylindrical electrode 21 is connected to another standard power supply different from the direct-current power supply 41 described later, the reference voltage in the standard power supply is adjusted to −1500 V or more and 1500 V or lower, for example.

The gas introduction port 21a is an opening for introducing a washing gas and a raw material gas into the reaction chamber 20 and is connected to the gas supply mechanism 70.

The plurality of gas outlets 21b are openings for blowing the washing gas and the raw material gas introduced into the cylindrical electrode 21 to the base 18 and are disposed at equal intervals in the vertical direction and the circumferential direction of FIG. 3. The plurality of gas outlets 21b are formed into the same circular shape and the pore size is adjusted to 0.5 mm or more 2.0 mm or lower. The pore size, shape, and arrangement of the plurality of gas outlets 21b can be changed as appropriate.

The plate 22 is structured in such a manner as to select the open state or the blocking state of the reaction chamber 20, and a support 31 described later can be taken in and out relative to the reaction chamber 20 by opening and closing the plate 22. The plate 22 is formed with the same conductive material as that of the base 18, and a deposition preventing plate 26 is attached to the side of a lower surface thereof. This prevents the formation of the deposition film on the plate 22. The deposition preventing plate 26 is formed with the same conductive material as that of the base 18 and is detachably attached to the plate 22.

The plate 23 serves as a base of the reaction chamber 20 and is formed with the same conductive material as that of the base 18. The insulation member 25 between the plate 23 and the cylindrical electrode 21 has a function of suppressing the occurrence of arc discharge between the cylindrical electrode 21 and the plate 23. Such an insulation member 25 can be formed with, for example, glass materials (borosilicate glass, soda glass, heat-resistant glass, etc.), inorganic insulation materials (ceramics, quartz, sapphire, etc.), or synthetic resin insulation materials (fluoride resin, polycarbonate, polyethylene terephthalate, polyester, polyethylene, polypropylene, polystyrene, polyamide, vinylon, epoxy, Mylar, PEEK material, etc.). However, the materials are not limited to the above-mentioned materials insofar as the materials have insulation properties, sufficient heat resistance at an operating temperature, and a low gas emission rate in a vacuum. The insulation member 25 is formed with a thickness equal to or higher than a fixed thickness in order to prevent the insulation member 25 from becoming unusable due to the occurrence of curvature by the internal stress of a film formed object and a stress resulting from the bimetal effect caused by an increase in a temperature during film formation. For example, when the insulation member 25 is formed with fluoride resin (coefficient of thermal expansion of 3×10⁻⁵/K or more and 10×10⁵/K or lower), the thickness of the insulation member 25 is set to 10 mm or more. When the thickness of the insulation member 25 is set in such a range, the degree of curvature resulting from the stress generated at the interface between the insulation member 25 and an a-Si film that is formed on the base 18 and has a thickness of 10 μm or more and 30 μm or lower can be set to 1 mm or lower in terms of a difference in the height in the axis direction between the end portion and the central portion in the horizontal direction, relative to the length in the horizontal direction of 200 mm (radial direction substantially orthogonal to the axis direction of the base 18). Thus, the insulation member 25 can be repeatedly used.

The plate 23 and the insulation member 25 are provided with gas exhaust ports 23A and 25A and a pressure gauge 27. The gas exhaust ports 23A and 25A have a function of discharging gas inside the reaction chamber 20 and is connected to an exhaust mechanism 80. The pressure gauge 27 has a function of monitoring the pressure of the reaction chamber 20 and various known pressure gauges can be used.

The support mechanism 30 supports the base 18 and has a function as a second conductor. The support mechanism 30 includes the support 31, a conductive column 32, and an insulation material 33. The support mechanism 30 in this embodiment is formed into a length (size) which allows supporting the two bases 18. The support 31 is detachably attached to the conductive support 32. According to such a structure, the two bases 18 can be taken in and out relative to the reaction chamber 20 without directly contacting the surface of the supported two bases 18.

The support 31 is a hollow member having a flange portion 31a and is entirely constituted as a conductor with the same conductive material as that of the base 18.

The conductive column 32 is a cylindrical member having a guide plate 32a and is entirely constituted as a conductor with the same conductive material as that of the base 18. The conductive column 32 is constituted so that the upper end contacts the inner surface of the support 31.

The insulation material 33 has a function of securing the electrical insulation between the conductive column 32 and the plate 23 and is present between the conductive column 32 and the plate 23 substantially at the center of the reaction chamber 20.

The direct-current voltage supply mechanism 40 is a mechanism for supplying a direct-current voltage to the conductive column 32 and has a direct-current power supply 41 and a control unit 42.

The direct-current power supply 41 has a function of generating a direct-current voltage to be applied to the conductive column 32 and is connected to the conductive column 32 through the guide plate 32a.

The control unit 42 has a function of controlling the operation of the direct-current power supply 41 and is connected to the direct-current power supply 41. The control unit 42 controls the operation of the direct-current power supply 41 and is constituted in such a manner as to apply a pulse-like direct-current voltage (see FIG. 4) to the support 31 through the conductive column 32.

The temperature control mechanism 50 has a function of controlling the temperature of the base 18 and has a ceramic pipe 51 and a heater 52.

The ceramic pipe 51 has a function of securing insulation and thermal conductivity and is accommodated in the conductive column 32.

The heater 52 has a function of heating the base 18 and is accommodated in the conductive column 32. The temperature of the base 18 is controlled by, for example, attaching a thermocouple (not shown) to the support 31 or the conductive column 32, and turning ON/OFF the heater 52 based on the monitor results. The temperature of the base 18 is maintained at a given temperature in the range of 200° C. or more and 400° C. or lower, for example. Examples of the heater 52 include a nichrome wire and a cartridge heater.

The rotation mechanism 60 has a function of rotating the support 31 and has a rotation motor 61, a rotation introduction terminal 62, an insulation axis member 63, and an insulation flat plate 64. When a film is formed by rotating the support mechanism 30 by the rotation mechanism 60, the base 18 is rotated with the support 31, which is preferable for substantially uniformly depositing decomposed components of a raw material gas on the outer circumference of the base 18.

The rotation motor 61 has a function of giving rotation force to the base 18. The operation of the rotation motor 61 is controlled so that the base 18 is rotated at a fixed number of rotations of, for example, 1 rpm or more and 10 rpm or lower. As the rotation motor 61, various known rotation motors can be used.

The rotation introduction terminal 62 has a function of transmitting the rotation force while maintaining the inside of the reaction chamber 20 at a predetermined vacuum degree. As such a rotation introduction terminal 62, vacuum seal measures, such as an oil seal or a mechanical seal, can be used when the rotation axis has a double or triple structure.

The insulation axis member 63 and the insulation flat plate 64 have a function of transmitting the rotation force from the rotation motor 61 to the support mechanism 30 while maintaining the insulation state between the support mechanism 30 and the plate 22 and are formed with the same insulation material as that of the insulation member 25. Here, the outer diameter of the insulation axis member 63 is adjusted to be smaller than the outer diameter (inner diameter an upper dummy base D3 described later) of the support 31 during film formation. More specifically, when the temperature of the base 18 during film formation is adjusted to 200° C. or more and 400° C. or lower, the outer diameter of the insulation axis member 63 is adjusted to be larger by 0.1 mm or more and 5 mm or lower and preferably about 3 mm than the outer diameter (inner diameter of the upper dummy base D3 described later) of the support 31. In order to satisfy the conditions, the difference between the outer diameter of the insulation axis member 63 and the outer diameter (inner diameter of the upper dummy base D3 described later) of the support 31 is adjusted to 0.6 mm or more and 5.5 mm or lower when a film is not formed (under a normal temperature environment (e.g., 10° C. or more and 40° C. or lower)).

The insulation flat plate 64 has a function of preventing foreign substances, such as wastes or dusts falling when the plate 22 is removed from adhering to the base 18. The insulation flat plate 64 is formed into a circular plate having an outer diameter larger than the inner diameter of the upper dummy base D3. The diameter of the insulation flat plate 64 is adjusted to be not less than 1.5 and not more than 3.0 times the diameter of the base 18. For example, when a base having a diameter of 30 mm is used as the base 18, the diameter of the insulation flat plate 64 is adjusted to about 50 mm. When such an insulation flat plate 64 is provided, unusual discharge resulting from foreign substances adhering to the base 18 can be suppressed. Thus, the occurrence of film formation defects can be suppressed. Thus, the yield when the electrophotographic photoreceptor 10 is formed is increased and the occurrence of image defects during image formation using the electrophotographic photoreceptor 10 can be suppressed.

The gas supply mechanism 70 contains a plurality of raw materials gas tanks 71, 72, 73, and 74, a plurality of pipings 71A, 72A, 73A, and 74A, valves 71B, 72B, 73B, 74B, 71C, 72C, 73C, and 74C, and a plurality of mass flow controllers 71D, 72D, 73D, and 74D, and is connected to the cylindrical electrode 21 through the piping 75 and the gas introduction port 21a.

The respective raw material gas tanks 71, 72, 73, and 74 are charged with a raw material gas. As the raw material gas, SiH₄, H₂, B₂H₆, CH₄, N₂, or NO is used.

The valves 71B, 72B, 73B, 74B, 71C, 72C, 73C, and 74C and the mass flow controllers 71D, 72D, 73D, and 74D have a function of adjusting the flow rate, composition, and gas pressure of gas components introduced into the reaction chamber 20. In the gas supply mechanism 70, the type of gas to be charged in the respective raw material gas tanks 71, 72, 73, and 74 or the number of the plurality of raw material gas tanks 71, 72, 73, and 74 may be determined as appropriate according to the type or composition of a film to be formed on the base 18.

The exhaust mechanism 80 has a function of discharging the gas of the reaction chamber 20 to the outside through the gas exhaust ports 23A and 25A and has a mechanical booster pump 81 and a rotary pump 82. The operation of these pumps 81 and 82 is controlled based on the monitoring results obtained by the pressure gauge 27. More specifically, with the exhaust mechanism 80, the reaction chamber 20 can be maintained at a given vacuum state and the gas pressure of the reaction chamber 20 can be adjusted to a target value based on the monitoring results obtained by the pressure gauge 27. The pressure of the reaction chamber 20 is adjusted to, for example, 1.0 Pa or more and 100 Pa or lower.

Next, a method for forming a deposition film using the plasma CVD device 2 is described with reference to the case where the electrophotographic photoreceptor 10 (FIG. 2) is produced as an example.

First, the plate 22 of the plasma CVD device 2 is removed, the support mechanism 30 on which a plurality of bases 18 (two bases 18 in FIG. 3) are supported is set in the reaction chamber 20, and then the plate 22 is attached again. The two bases 18 in the support mechanism 30 are supported by successively placing a lower dummy base D1, the base 18, an intermediate dummy base D2, the base 18, and an upper dummy base D3 one upon another on a flange portion 31a of the support 31. Examples of the respective dummy bases D1, D2, and D3 include a base having conductivity throughout the base or a base having a conductive film formed on the surface of an insulator. Among the above, a base having the same structure as that of the base 18 is particularly preferable. The lower dummy base D1 has a function of adjusting the height position of the base 18. The intermediate dummy base D2 has a function of suppressing the occurrence of arc discharge between the ends of the adjacent bases 18. As the intermediate dummy base D2, a base is employed whose length is adjusted to the length (e.g., 1 cm or more) which allows sufficiently suppressing the occurrence arc discharge and whose corner portions at the outer circumferential surface is subjected to curved surface processing (e.g., curvature radius of 0.5 mm or more) or chamfering (the length in the axis direction and the length in the depth direction in a cut portion are 0.5 mm or more, respectively). The upper dummy base D3 has a function of suppressing the formation of a deposition film on the support 31. As the upper dummy base D3, a base having a portion projecting from the uppermost portion of the support 31 is employed.

Subsequently, the temperature of the base 18 is adjusted to a given temperature by the temperature control mechanism 50 and the pressure of the reaction chamber 20 is reduced by the exhaust mechanism 80. With reference to the control of the temperature of the base 18, the temperature of the base 18 is increased to the neighborhood of a given temperature by heating the heater 52, and thereafter the temperature of the base 18 is maintained at a given temperature by turning on or turning off the heater 52. The temperature of the base 18 is determined as appropriate in accordance with the type and composition of a film to be formed on the surface and is determined in the range of 250° C. or more and 300° C. or lower when an a-Si film is formed, for example. In contrast, the pressure of the reaction chamber 20 is reduced by discharging gas from the reaction chamber 20 through the gas exhaust ports 23A and 25A by controlling the operation of the mechanical booster pump 81 and the rotary pump 82 while monitoring the pressure of the reaction chamber 20 by the pressure gauge 27. The pressure of the reaction chamber 20 is reduced to reach about 1×10⁻³ Pa, for example.

Subsequently, the temperature of the base 18 is maintained at a given temperature, a raw material gas is supplied to the reaction chamber 20 by the gas supply mechanism 70 in a state where the pressure of the reaction chamber 20 is reduced to a given pressure, and a pulse-like direct-current voltage is applied between the cylindrical electrode 21 and the support 31. Thus, glow discharge occurs between the cylindrical electrode 21 and the support 31 (base 18) to decompose a raw material gas, and the decomposed components are deposited on the surface of the base 18. In the exhaust mechanism 80, the pressure of the reaction chamber 20 is maintained in a given range (e.g., 1.0 Pa or more and 100 Pa or lower) by controlling the operation of the mechanical booster pump 81 and the rotary pump 82 while monitoring the pressure gauge 27. More specifically, the pressure in the reaction chamber 20 is maintained in a given range by the mass flow controllers 71D, 72D, 73D, and 74D in the gas supply mechanism 70 and the pumps 81 and 82 in the exhaust mechanism 80. The raw material gas is supplied to the reaction chamber 20 by introducing the raw material gas of the raw material gas tanks 71, 72, 73, and 74 into the cylindrical electrode 21 with a desired composition and at a desired flow rate through the pipings 71A, 72A, 73A, 74A, and 75 and the gas introduction port 21a by controlling the mass flow controllers 71D, 72D, 73D, and 74D while controlling as appropriate the opening and closing state of the valves 71B, 72B, 73B, 74B, 71C, 72C, 73C, and 74C. The raw material gas introduced into the cylindrical electrode 21 is blown off to the base 18 through the plurality of gas outlets of 21b. Then, the composition of the raw material gas is changed as appropriate by the valves 71B, 72B, 73B, 74B, 71C, 72C, 73C, and 74C and the mass flow controllers 71D, 72D, and 73D, and 74D. In contrast, when the cylindrical electrode 21 is grounded, the pulse-like direct-current voltage is applied between the cylindrical electrode 21 and the support 31 in such a manner as to achieve a negative pulse-like direct-current potential V1 (FIG. 4) of −3000 V or more and −50 V or lower (preferably, −3000 V or more and −500 V or lower). When the cylindrical electrode 21 is connected to the standard power supply (not shown), the application is performed in such a manner as to achieve a target potential difference ΔV (e.g., −3000 V or more and −50 V or lower) based on a potential V2 supplied by the standard power supply as the standard potential. When a negative pulse-like voltage (FIG. 4) is applied to the support 31 (base 18), the potential V2 supplied by the standard power supply is adjusted to, for example, —1500 V or more and 1500 V or lower. The control unit 42 controls the direct-current power supply 41 so that the frequency (1/T (sec)) of the direct-current voltage is 300 kHz or lower and the duty ratio (T1/T) is 20% or more and 90% or lower. The duty ratio in this embodiment is defined as a time ratio occupied by a potential difference generating time T1 in one cycle T of the pulse-like direct-current voltage (time from the moment when a potential difference arises between the base 18 and the cylindrical electrode 21 to the moment when a potential difference arises next) as shown in FIG. 4. For example, the duty ratio of 20% means that the potential difference generating time in one cycle when the pulse-like voltage is applied occupies 20% in the entire one cycle. As described above, the photoconductive layer 19A, the charge injection blocking layer 19B, and the surface layer 19C are successively laminated on the surface of the base 18. When the charge injection blocking layer 19D is further formed, the charge injection blocking layer 19D, the photoconductive layer 19A, the charge injection blocking layer 19B, and the surface layer 19C are successively laminated on the surface of the base 18.

In the electrophotographic photoreceptors 10 having the above-described structure, the optical absorption coefficient of the charge injection blocking layer 19B is adjusted to be smaller than the optical absorption coefficient of the photoconductive layer 19A as shown in each Example described later. Therefore, in the electrophotographic photoreceptor 10, the loss of light (e.g., exposure light or neutralization light) in the charge injection blocking layer 19B can be suppressed. Moreover, in the electrophotographic photoreceptor 10, the difference between the refractive index of the photoconductive layer 19A and the refractive index of the charge injection blocking layer 19B is adjusted to be more than 0 and 0.9 or lower as shown in each Example described later. Therefore, in the electrophotographic photoreceptor 10, the reflection of light between the charge injection blocking layer 19B and the photoconductive layer 19A can be sufficiently reduced. Therefore, the electrophotographic photoreceptor 10 can more effectively perform exposure, neutralization, etc., and thus is preferable for suppressing a reduction in image quality due to residual potential while sufficiently maintaining the contrast of images to be formed.

In the electrophotographic photoreceptor 10, the charge injection blocking layer 19B contains at least one element selected from the group consisting of N, O, and C, and thus the optical band gap can be enlarged (the optical absorption coefficient can be made small). Moreover, in the electrophotographic photoreceptor 10, the charge injection blocking layer 19B contains the Group 13 elements, and thus can appropriately prevent the charged charge on the surface of the electrophotographic photoreceptor 10 from being poured into the side of the photoconductive layer 19A.

When the element selected from the group consisting of N, O, and C in the electrophotographic photoreceptor 10 is substantially only N, it is preferable for increasing the optical band gap in the charge injection blocking layer 19B without unreasonably increasing the insulation properties of the charge injection blocking layer 19B. This is because the element of O is preferable for increasing the optical band gap but the insulation is relatively likely to increase, and thus inhibitory effects of a reduction in image quality due to residual potential are not sufficiently obtained in some cases and the element of C is preferable for suppressing an unreasonable increase in insulation properties but the optical band gap is relatively hard to increase, and inhibitory effects of the light loss by reducing the optical absorption coefficient are not sufficiently obtained in some cases.

When the Group 13 element is boron in the electrophotographic photoreceptor 10, it is preferable for more appropriately forming a P type barrier in the charge injection blocking layer 19B. This is because a hydrogen compound (e.g., B₂H₆) of boron is present in the form of gas at room temperature, the doping concentration during film formation by a CVD (Chemical Vapor Deposition) method is likely to control, compared with gallium, aluminum, indium, etc.

When the charge injection blocking layer 19B is formed by the CVD method in which the pulse-like direct-current voltage is applied in the electrophotographic photoreceptor 10, a higher electrical resistance ability can be achieved compared with the CVD film formation performed using a conventional power supply of the RF band or the VHF band. This is because the energy when ion species decomposed by plasma collide against the base is large compared with conventional film formation methods (using a power supply of the RF band or the VIIF band) and a sputtering phenomenon arises, and thus a smoother surface is obtained.

When the charge injection blocking layer 19D is further formed between the base 18 and the photoconductive layer 19A in the electrophotographic photoreceptor 10, the injection of charge into the side of the photoconductive layer 19A from the base 18 can be appropriately prevented. Therefore, for example, the charge that is negatively charged on the surface of the electrophotographic photoreceptor 10 is prevented from being cancelled by injection of positive charge from the base 18. Therefore, in the electrophotographic photoreceptor 10 having the structure, the charge properties increase, and thus a higher charge voltage (surface potential) can be secured.

The image forming device 1 according to this embodiment has the electrophotographic photoreceptor 10, and thus is preferable for suppressing a reduction in image quality due to residual potential while sufficiently maintaining the contrast of images to be formed.

### First Example

### <Production of Electrophotographic Photoreceptor>

Electrophotographic photoreceptors were produced using an aluminum alloy material tube (Outer diameter: 84 mm, Length: 360 mm) as a cylindrical base. To the aluminum material tube, a photosensitive layer (a lower charge injection blocking layer, a photoconductive layer, an upper charge injection blocking layer, and a surface layer) was formed under the conditions shown in Tables 1 and 2 using the plasma CVD device shown in FIG. 3. As a power supply of the plasma CVD device, a direct-current pulse power supply (pulse frequency: 50 kHz, Duty ratio: 70%) was used. The film thickness t of the upper charge injection blocking layer was set to be 0.5 μm. Here, the film thickness was measured by analyzing the cross section by SEM and XMA.

TABLE 1

| | | Charge | | Charge | |
|---|---|---|---|---|---|
| | | injection | | injection | |
| | | blocking | Photoconductive | blocking | Surface |
| | | layer | layer | layer | layer |
| Layer type | | (19D) | (19A) | (19B) | (19C) |
| Gas | SiH₄ [sccm] | 170 | 340 | 340 | 30 |
| type | H₂ [sccm] | 200 | 200 | 200 | 0 |
| | B₂H₆ [ppm] | 1150 | 0.3 | 3000 | 0 |
| | CH₄ [sccm] | 0 | 0 | 0 | 600 |
| | N₂ [sccm] | 0 | 0 | 0 to 100 | 0 |

| | | | | |
|---|---|---|---|---|
| Pressure [Pa] | 80 | 80 | 80 | 86.5 |
| Base | 300 | 320 | 320 | 250 |
| temperature | | | | |
| [° C.] | | | | |
| Direct current | −665 | −735 | −735 | −280 |
| voltage [V] | | | | |
| Pulse frequency | 50 | 50 | 50 | 50 |
| [kHz] | | | | |
| Duty ratio [%] | 70 | 70 | 70 | 70 |
| Film thickness | 5 | 20 | 0.5 | 1 |
| [μm] | | | | |

TABLE 2

| | | | Optical | | | |
|---|---|---|---|---|---|---|
| | N₂ flow | Refractive | absorption | Surface | Half decay | |
| | rate | index | coefficient | potential | exposure | |
| | [sccm] | [—] | [cm⁻¹] | [V] | [μJ/cm²] | Image quality |
| Example 1 | 50 | 3.1 | 1600 | 450 | 0.25 | [symbol] |
| Example 2 | 40 | 3.3 | 1950 | 400 | 0.30 | [symbol] |
| Example 3 | 25 | 3.5 | 2400 | 300 | 0.33 | [symbol] |
| Example 4 | 10 | 3.9 | 3850 | 270 | 0.40 | ◯ |
| Comparative | 0 | 4.0 | 5000 | 200 | 0.22 | X |
| Example 1 | | | | | | |
| Comparative | 60 | 3.0 | 1350 | 460 | 0.36 | X |
| Example 2 | | | | | | |
| Comparative | 70 | 2.7 | 1000 | 465 | 0.37 | X |
| Example 3 | | | | | | |
| Comparative | 100 | 2.5 | 760 | 470 | 0.38 | X |
| Example 4 | | | | | | |

### <Measurement of Refractive Index>

First, test pieces were produced by forming an about 1 μm thick single layer film (a film having substantially the same structure as that of the upper charge injection blocking layer) on a glass substrate. Next, the wavelength dependence (wavelength range: 400 nm to 800 nm) of the transmittance of transmitted light emitted to the produced test pieces was measured using a ultraviolet and visible spectrophotometer (UV-2400PC, manufactured by Shimadzu Corp.). Next, by fitting the measurement results to the calculated values obtained from optical calculation, the refractive index of the test piece corresponding to each electrophotographic photoreceptor was derived and the results were shown in Table 2. The refractive index of the photoconductive layer was 4.0 in all the electrophotographic photoreceptors.

### <Measurement of Optical Absorption Coefficient>

First, test pieces were produced by forming an about 1 μm thick single layer film (a film having substantially the same structure as that of the upper charge injection blocking layer) on a glass substrate. Next, the transmittance (wavelength range: 400 nm to 800 nm) of transmitted light emitted to the produced test pieces was measured using a ultraviolet and visible spectrophotometer (UV-2400PC, manufactured by Shimadzu Corp.). Next, the optical absorption coefficient of the test piece corresponding to each electrophotographic photoreceptor was derived based on the measured results and the results were shown in Table 2. The optical absorption coefficient of the photoconductive layer was 4500 cm⁻¹ in all the electrophotographic photoreceptors.

### <Measurement of Surface Potential>

Each electrophotographic photoreceptor was mounted on an image forming device (KM-8030, manufactured by KYOCERA MITA CORP.). Then, the surface potential when a charge of 0.3 μC/cm² was applied, with minus potential, to the surface of the electrophotographic photoreceptor was measured with a surface potentiometer (MODEL 344 manufactured by Trek Japan Co., Ltd.) disposed at a development position. The measurement results were shown in Table 2.

### <Measurement of Half Decay Exposure>

Each electrophotographic photoreceptor was mounted on an image forming device (KM-8030, manufactured by KYOCERA MITA CORP.). Then, in a state where a charge of 0.3 μC/cm² was applied, with minus potential, to the surface of the electrophotographic photoreceptor, the electrophotographic photoreceptor is irradiated with exposure light (wavelength: 680 nm) while rotating (number of rotations: 100 rpm) the electrophotographic photoreceptor. Then, the exposure amount in which the surface potential in each electrophotographic photoreceptor is equal to ½ of the difference between the surface potential after charging and the surface potential after neutralization was defined as a half decay exposure, and the half decay exposure was measured with a surface potentiometer (MODEL 344 manufactured by Trek Japan Co., Ltd.) disposed at a development position. The measurement results were shown in Table 2.

### <Measurement of Image Quality>

Each electrophotographic photoreceptor was mounted on an image forming device (KM-8030, manufactured by KYOCERA MITA CORP.), and given images are output to A4 sized blank paper for office machinery. Then, white image fogging, the concentration of black images, and the gradation of intermediate gray images in the output images were visually confirmed, and evaluated based on the following criteria. The evaluation results were shown in Table 2. In the following criteria, the image quality was evaluated as follows: the case where the concentration of black images is sufficient, the gradation of intermediate gray images is also good enough, and white image fogging does not substantially occur was evaluated as “ [symbol] ”, the case where the concentration of black images is insufficient and the gradation of intermediate gray images is not sufficiently good but white image fogging does not substantially occur, which causes no problems for practical use, was evaluated as “∘”, and the case where white image fogging was observed and the gradation of intermediate gray images is not sufficient was evaluated as “×”. Here, the “fogging” means that, when white images are enlarged and observed, minute black points are present in the entire images, i.e., a so-called worsened white spot state.

### <Evaluation>

In the electrophotographic photoreceptors of Examples 1 to 4, the optical absorption coefficient of the upper charge injection blocking layer was smaller than the optical absorption coefficient (4500 cm⁻¹) of the photoconductive layer, and thus the loss of light in the charge injection blocking layer was sufficiently suppressed. Moreover, in the electrophotographic photoreceptors of Examples 1 to 4, the difference between the refractive index of the upper charge injection blocking layer and the refractive index (4.0) of the photoconductive layer was more than 0 and 0.9 or lower, and thus the reflection of light between the charge injection blocking layer and the photoconductive layer was sufficiently reduced. Therefore, the electrophotographic photoreceptors of Examples 1 to 4 can suppress a reduction in image quality due to residual potential while sufficiently maintaining the contrast of images to be formed, and, as a result, sufficient image quality was obtained under visual observation.

In contrast, in the electrophotographic photoreceptor of Comparative Example 1, the optical absorption coefficient of the upper charge injection blocking layer was larger than the optical absorption coefficient (4500 cm⁻¹) of the photoconductive layer, and thus the loss of light in the charge injection blocking layer was not sufficiently suppressed. In addition, in the electrophotographic photoreceptor of Comparative Example 1, the upper charge injection blocking layer does not substantially contain any element of N, O, or C, and thus given insulation properties were not secured in the upper charge injection blocking layer and surface potential (e.g., 250 V or more) required for sufficiently maintaining the contrast of images to be formed was not secured. Moreover, in the electrophotographic photoreceptors of Comparative Examples 2 to 4, the difference between the refractive index of the upper charge injection blocking layer and the refractive index (4.0) of the photoconductive layer exceeded 0.9, and thus the reflection of light between the charge injection blocking layer and the photoconductive layer was not sufficiently reduced, and, as a result, high residual potential generated. Therefore, in the electrophotographic photoreceptors of Comparative Examples 1 to 4, the contrast of images to be formed was not sufficiently maintained or a reduction in image quality due to residual potential was not suppressed, and, as a result, sufficient image quality was not obtained under visual observation.

### Second Example

### <Production of Electrophotographic Photoreceptor>

Electrophotographic photoreceptors were produced by forming a photosensitive layer under the conditions shown in Tables 3 and 4 in the same manner as in the First Example. The refractive index, the optical absorption coefficient, the surface potential, the half decay exposure, and the image quality were measured in the same manner as in the First Example, and the measurement results were shown in Table 4.

TABLE 3

| | | Charge | | Charge | |
|---|---|---|---|---|---|
| | | injection | | injection | |
| | | blocking | Photoconductive | blocking | Surface |
| | | layer | layer | layer | layer |
| Layer type | | (19D) | (19A) | (19B) | (19C) |
| Gas | SiH₄ [sccm] | 170 | 340 | 340 | 30 |
| type | H₂ [sccm] | 200 | 200 | 200 | 0 |
| | B₂H₆ [ppm] | 1150 | 0.3 | 3000 | 0 |
| | CH₄ [sccm] | 0 | 0 | 3 to 30 | 600 |
| | N₂ [sccm] | 0 | 0 | 10 to 60 | 0 |

| | | | | |
|---|---|---|---|---|
| Pressure [Pa] | 80 | 80 | 80 | 86.5 |
| Base | 300 | 320 | 320 | 250 |
| temperature | | | | |
| [° C.] | | | | |
| Direct current | −665 | −735 | −735 | −280 |
| voltage [V] | | | | |
| Pulse frequency | 50 | 50 | 50 | 50 |
| [kHz] | | | | |
| Duty ratio [%] | 70 | 70 | 70 | 70 |
| Film thickness | 5 | 20 | 0.5 | 1 |
| [μm] | | | | |

TABLE 4

| | N₂ | CH₄ | | Optical | | Half | |
|---|---|---|---|---|---|---|---|
| | flow | flow | Refractive | absorption | Surface | decay | |
| | rate | rate | index | coefficient | potential | exposure | Image |
| | [sccm] | [sccm] | [—] | [cm⁻¹] | [V] | [μJ/cm²] | quality |
| Example 5 | 10 | 10 | 3.8 | 3000 | 450 | 0.36 | [symbol] |
| Example 6 | 20 | 7 | 3.4 | 2950 | 400 | 0.30 | [symbol] |
| Example 7 | 35 | 5 | 3.5 | 2200 | 400 | 0.33 | [symbol] |
| Example 8 | 50 | 3 | 3.2 | 1780 | 500 | 0.35 | ◯ |
| Comparative | 60 | 30 | 2.8 | 1020 | 520 | 0.40 | X |
| Example 5 | | | | | | | |

### <Evaluation >

In all the electrophotographic photoreceptors of Examples 5 to 8, the optical absorption coefficient of the upper charge injection blocking layer was smaller than the optical absorption coefficient (4500 cm⁻¹) of the photoconductive layer, and thus the loss of light in the charge injection blocking layer was sufficiently suppressed. Moreover, in the electrophotographic photoreceptors of Examples 5 to 8, the difference between the refractive index of the upper charge injection blocking layer and the refractive index (4.0) of the photoconductive layer was more than 0 and 0.9 or lower, and thus the reflection of light between the charge injection blocking layer and the photoconductive layer was sufficiently reduced. Therefore, in the electrophotographic photoreceptors of Examples 5 to 8, a reduction in image quality due to residual potential can be suppressed while sufficiently maintaining the contrast of images to be formed, and, as a result, sufficient image quality was obtained under visual observation.

In contrast, in the electrophotographic photoreceptor of Comparative Example 5, since the difference between the refractive index of the upper charge injection blocking layer and the refractive index (4.0) of the photoconductive layer exceeded 0.9, the reflection of light between the charge injection blocking layer and the photoconductive layer was not sufficiently reduced, and, as a result, high residual potential generated. Therefore, in the electrophotographic photoreceptor of Comparative Example 5, a reduction in image quality due to residual potential was not suppressed, and, as a result, sufficient image quality was not obtained under visual observation.

### Third Example

### <Production of Electrophotographic Photoreceptor>

Electrophotographic photoreceptors were produced by forming a photosensitive layer under the conditions shown in Tables 5 and 6 in the same manner as in the First Example. The refractive index, the optical absorption coefficient, the surface potential, the half decay exposure, and the image quality were measured in the same manner as in the First Example, and the measurement results were shown in Table 6.

TABLE 5

| | | Charge | | Charge | |
|---|---|---|---|---|---|
| | | injection | | injection | |
| | | blocking | Photoconductive | blocking | Surface |
| | | layer | layer | layer | layer |
| Layer type | | (19D) | (19A) | (19B) | (19C) |
| Gas | SiH₄ [sccm] | 170 | 340 | 340 | 30 |
| type | H₂ [sccm] | 200 | 200 | 200 | 0 |
| | B₂H₆ [ppm] | 1150 | 0.3 | 3000 | 0 |
| | CH₄ [sccm] | 0 | 0 | 0 | 600 |
| | NO[sccm] | 0 | 0 | 5 to 50 | 0 |

| | | | | |
|---|---|---|---|---|
| Pressure [Pa] | 80 | 80 | 80 | 86.5 |
| Base | 300 | 320 | 320 | 250 |
| temperature | | | | |
| [° C.] | | | | |
| Direct current | −665 | −735 | −735 | −280 |
| voltage [V] | | | | |
| Pulse frequency | 50 | 50 | 50 | 50 |
| [kHz] | | | | |
| Duty ratio [%] | 70 | 70 | 70 | 70 |
| Film thickness | 5 | 20 | 0.5 | 1 |
| [μm] | | | | |

TABLE 6

| | N₂ | | Optical | | Half | |
|---|---|---|---|---|---|---|
| | flow | Refractive | absorption | Surface | decay | |
| | rate | index | coefficient | potential | exposure | |
| | [sccm] | [—] | [cm⁻¹] | [V] | [μJ/cm²] | Image quality |
| Example 9 | 20 | 3.1 | 1690 | 460 | 0.32 | [symbol] |
| Example 10 | 10 | 3.5 | 2220 | 320 | 0.30 | [symbol] |
| Example 11 | 5 | 3.8 | 3600 | 280 | 0.40 | ◯ |
| Comparative | 30 | 2.5 | 1040 | 400 | 0.39 | X |
| Example 6 | | | | | | |
| Comparative | 40 | 2.1 | 1350 | 450 | 0.47 | X |
| Example 7 | | | | | | |
| Comparative | 50 | 2.0 | 550 | 490 | 0.56 | X |
| Example 8 | | | | | | |

### <Evaluation>

In all the electrophotographic photoreceptors of Examples 9 to 11, the optical absorption coefficient of the upper charge injection blocking layer was smaller than the optical absorption coefficient (4500 cm⁻¹) of the photoconductive layer, and thus the loss of light in the charge injection blocking layer was sufficiently suppressed. Moreover, in the electrophotographic photoreceptors of Examples 9 to 11, the difference between the refractive index of the upper charge injection blocking layer and the refractive index (4.0) of the photoconductive layer was more than 0 and 0.9 or lower, and thus the reflection of light between the charge injection blocking layer and the photoconductive layer was sufficiently reduced. Therefore, in the electrophotographic photoreceptors of Examples 9 to 11, a reduction in image quality due to residual potential can be suppressed while sufficiently maintaining the contrast of images to be formed, and, as a result, sufficient image quality was obtained under visual observation.

In contrast, in the electrophotographic photoreceptors of Comparative Examples 6 to 8, since the difference between the refractive index of the upper charge injection blocking layer and the refractive index (4.0) of the photoconductive layer exceeded 0.9, the reflection of light between the charge injection blocking layer and the photoconductive layer was not sufficiently reduced, and, as a result, high residual potential generated. Therefore, in the electrophotographic photoreceptors of Comparative Example 6 to 8, a reduction in image quality due to residual potential was not suppressed, and, as a result, sufficient image quality was not obtained under visual observation.

### Fourth Example

### <Production of Electrophotographic Photoreceptor>

Electrophotographic photoreceptors were produced by forming a photosensitive layer while changing the film thickness of the upper charge injection blocking layer as shown in Tables 7 and 8 under the same conditions as those of the First and Fourth Examples. The film thickness, the surface potential, the half decay exposure, and the image quality were measured in the same manner as in the First Example, and the measurement results were shown in Tables 7 and 8.

TABLE 7

| | Film | | | |
|---|---|---|---|---|
| | thickness | | | |
| | of charge | | | |
| | injection | | | |
| | blocking | | | |
| | layer | Surface | Half decay | |
| | (19B) | potential | exposuer | Image |
| | [μm] | [V] | [μJ/cm²] | quality |
| Comparative | 0 | 200 | 0.20 | X |
| Example 9 | | | | |
| Example 12 | 0.1 | 400 | 0.23 | [symbol] |
| Example 1 | 0.5 | 450 | 0.25 | [symbol] |
| Example 13 | 0.9 | 470 | 0.27 | [symbol] |
| Example 14 | 1.0 | 480 | 0.32 | [symbol] |

TABLE 8

| | Film | | | |
|---|---|---|---|---|
| | thickness | | | |
| | of charge | | | |
| | injection | | | |
| | blocking | | | |
| | layer | Surface | Half decay | |
| | (19B) | potential | exposure | Image |
| | [μm] | [V] | [μJ/cm²] | quality |
| Comparative | 0 | 200 | 0.20 | X |
| Example 10 | | | | |
| Example 15 | 0.1 | 250 | 0.31 | [symbol] |
| Example 4 | 0.5 | 270 | 0.40 | [symbol] |
| Example 16 | 0.9 | 285 | 0.42 | [symbol] |
| Example 17 | 1.0 | 300 | 0.45 | [symbol] |

### <Evaluation >

In all the electrophotographic photoreceptors of Examples 12 to 17, the optical absorption coefficient of the upper charge injection blocking layer was smaller than the optical absorption coefficient (4500 cm⁻¹) of the photoconductive layer similarly as in Examples 1 and 4, and thus the loss of light in the charge injection blocking layer was sufficiently suppressed. Moreover, in the electrophotographic photoreceptors of Examples 12 to 17, the difference between the refractive index of the upper charge injection blocking layer and the refractive index (4.0) of the photoconductive layer was more than 0 and 0.9 or lower similarly as in Examples 1 and 4, and thus the reflection of light between the charge injection blocking layer and the photoconductive layer was sufficiently reduced. Therefore, in the electrophotographic photoreceptors of Examples 1, 4, and 12 to 17, a reduction in image quality due to residual potential can be suppressed while sufficiently maintaining the contrast of images to be formed, and, as a result, sufficient image quality was obtained under visual observation. The results of the Examples show that the target functions are sufficiently achieved when the film thickness of the upper charge injection blocking layer is 1.0 μm or lower and it is hard to consider, in practice, performing film formation so that the film thickness exceeds 1.0 μm from the viewpoint of film formation time. Thus, the film thickness of experiment targets was 1.0 μm or lower.

In contrast, the electrophotographic photoreceptors of Comparative Examples 9 and 10 do not have the upper charge injection blocking layer itself, and thus given insulation was not secured and a surface potential (e.g., 250 V or more) required to sufficiently maintain the contrast of images to be formed was not secured. Therefore, in the electrophotographic photoreceptors of Comparative Examples 9 to 10, the contrast of images to be formed was not sufficiently maintained, and, as a result, sufficient image quality was not obtained under visual observation.

### Fifth Example

### <Production of Electrophotographic Photoreceptor>

An electrophotographic photoreceptor of Comparative Example 10 was produced by performing CVD film formation at the same gas ratio as that in Example 1 of the First Example using a high frequency power supply of RF (Frequency: 13.56 MHz). Separately, an electrophotographic photoreceptor of Comparative Example 11 was produced by performing CVD film formation at the same gas ratio as that in Example 1 of the First Example using a high frequency power supply of VHF (Frequency: 50 MHz). The CVD film formation in the Comparative Examples was performed replacing the power supply of the plasma CVD device shown in FIG. 3 with a given power supply.

### <Measurement of Discharge Breakdown Voltage>

A voltage was applied to a needle disposed at a given distance (1 mm) from the surface of the electrophotographic photoreceptor while gradually increasing the voltage. Then, a voltage when the insulation of the electrophotographic photoreceptor was broken was measured as a discharge breakdown voltage. The measurement results were shown in Table 9.

TABLE 9

| | Discharge |
|---|---|
| | Breakdown |
| | Voltage |
| | [kV] |
| Example 1 | 2.4 |
| Comparative | 2.0 |
| Example 11 | |
| Comparative | 1.9 |
| Example 12 | |

### <Evaluation>

In the electrophotographic photoreceptor of Example 1, the discharge breakdown voltage was higher than that of the electrophotographic photoreceptors of Comparative Examples 11 and 12. Thus, the electrophotographic photoreceptor of Example 1 has higher electrical resistance ability compared with the electrophotographic photoreceptors of Comparative Examples 11 and 12. Therefore, it was confirmed that the occurrence of insufficient charge resulting from breakdown of electrical resistance, consequently the occurrence of image defects, was further suppressed.

### BRIEF DESCRIPTION OF DRAWINGS

FIG. 1 is a cross sectional view showing a schematic structure of one example of an image forming device according to an embodiment of the present invention.

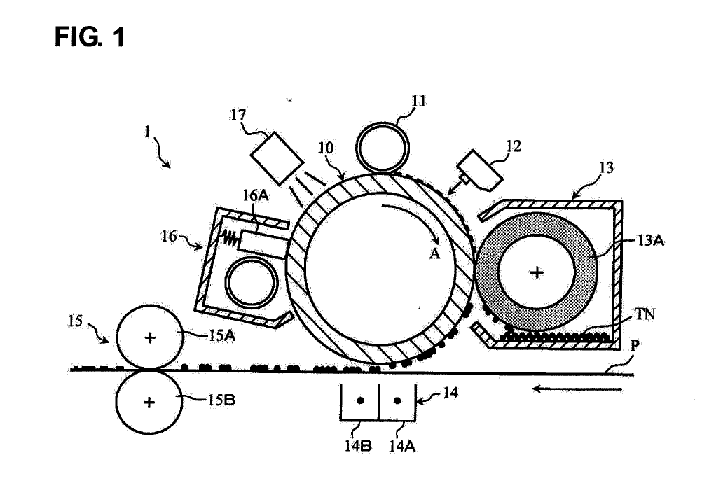

FIG. 2 is a view showing a negative charging electrophotographic photoreceptor according to an embodiment of the present invention, in which FIG. 2(a) is a cross sectional view and an enlarged view of the essential part of an example thereof and FIG. 2(b) is an enlarged view of the essential part of another example.

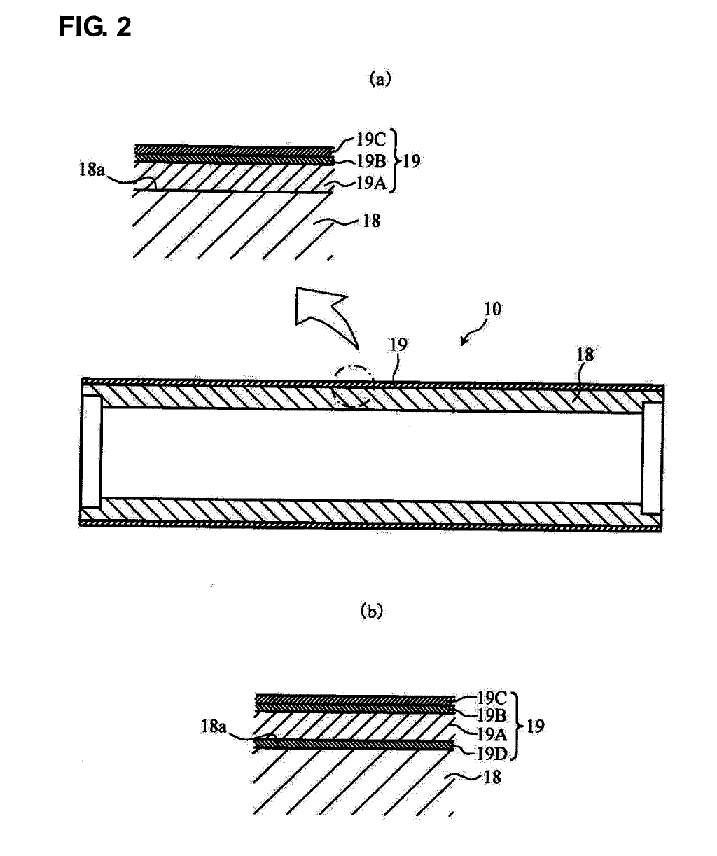

FIG. 3 is a cross sectional view showing an example of a plasma CVD device for forming a photosensitive layer of the electrophotographic photoreceptor shown in FIG. 2.

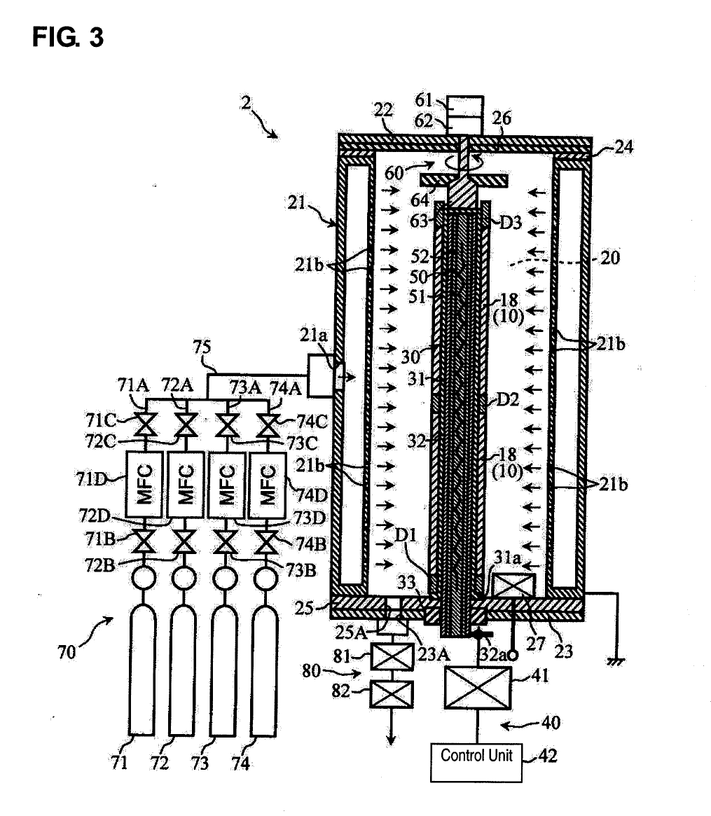

FIG. 4 is a graph for describing a voltage application state in the plasma CVD device shown in FIG. 3.

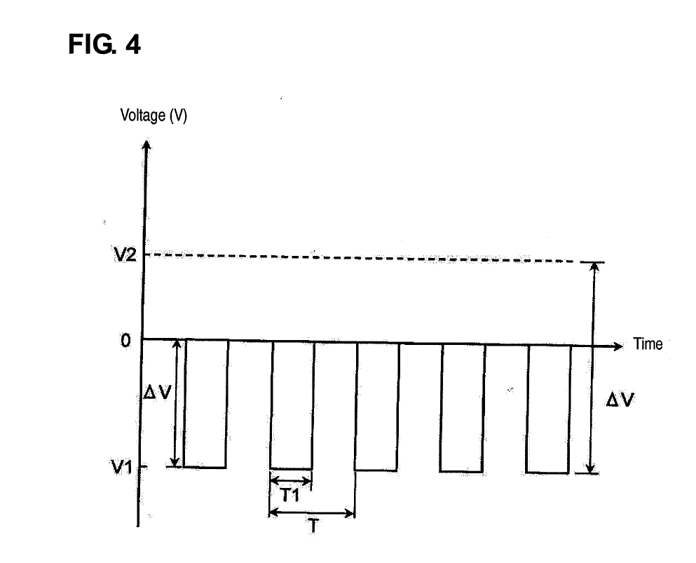

### REFERENCE NUMERALS

1 Image forming device

2 Plasma CVD device

3 Support

4 Reaction chamber

5 Rotation member

6 Gas supply member

7 Exhaust member

10 Negative charging electrophotographic photoreceptor

11 Charging unit

12 Exposure unit

13 Development unit

14 Transfer unit

15 Fixing unit

16 Cleaning unit

17 Neutralization unit

18 Cylindrical base (Base)

19 Photosensitive layer

19A Photoconductive layer

19B Charge injection blocking layer

19C Surface layer

1. An electrophotographic photoreceptor, comprising:
a base,
a photoconductive layer containing a non-single crystal material mainly including a silicon atom and positioned on the base,
a charge injection blocking layer positioned on the photoconductive layer, and
a surface layer positioned on the charge injection blocking layer,
the charge injection blocking layer containing at least one element selected from the group consisting of N, O, and C and at least one of Group 13 elements,
the optical absorption coefficient of the charge injection blocking layer being smaller than the optical absorption coefficient of the photoconductive layer, and
a difference between the refractive index of the photoconductive layer and the refractive index of the charge injection blocking layer being more than 0 and 0.9 or lower.

2. The electrophotographic photoreceptor according to claim 1, wherein the element selected from the group consisting of N, O, and C is substantially only N.

3. The electrophotographic photoreceptor according to claim 1, wherein the at least one of Group 13 elements is boron.

4. The electrophotographic photoreceptor according to claim 1, wherein the charge injection blocking layer is formed by a CVD method in which a pulse-like direct-current voltage is applied.

5. The electrophotographic photoreceptor according to claim 1, further comprising another charge injection blocking layer between the base and the photoconductive layer.

6. An image forming device, comprising the electrophotographic photoreceptor according to claim 1.
